(19) United States
(12) Patent Application Publication
(10) Pub. No.: US 2009/0059067 A1
(43) Pub. Date: Mar. 5, 2009

(54) MOTION VECTOR DETECTION APPARATUS, METHOD OF DETECTING MOTION VECTORS, AND IMAGE DISPLAY DEVICE

(76) Inventors: Kenta Takanohashi, Yokohama (JP); Masahiro Ogino, Ebina (JP); Yoshiaki Mizuhashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/020,771

(22) Filed: Jan. 28, 2008

(30) Foreign Application Priority Data
Jan. 26, 2007 (JP) 2007-016311

(51) Int. Cl. H04N 7/01; H04N 5/14

(52) U.S. Cl. 348/452; 348/699; 348/E07.003

(57) ABSTRACT

A motion vector detection apparatus is disclosed capable of detecting accurate motion vectors from between a previous frame of image and the presently displayed frame of image even in edge regions of the frames where inaccurate motion vectors would normally tend to be detected. A motion vector-detecting portion reads in an image signal from the signal input portion as well as image signals entered through first through third frame memories. Processing for detecting motion vectors is performed, based on four frames entered in synchronism to the motion vector-detecting portion out of the frames forming the image signals. Vectors produced between the image signal from the first frame memory delayed by one frame relative to the image signal from the signal input portion and the image signal from the second frame memory delayed by two frames relative to the image signal from the signal input portion are detected as motion vectors.

### INCORPORATION BY REFERENCE

The present application claims priority from Japanese application JP2007-016311 filed on Jan. 26, 2007, the content of which is hereby incorporated by reference into this application.

### BACKGROUND OF THE INVENTION

The present invention relates to a motion vector detection apparatus for finding motion vectors from an image signal in a digital format. The invention also relates to a method of detecting motion vectors and to an image display device equipped with such a motion vector detection apparatus.

A motion vector is a vector connecting pixels which show the best match when a preceding frame of image (image displayed in the past) is matched to the presently displayed frame of image. The matching is performed within a given search area to determine motion vectors. In other words, a motion vector technique is a method of expressing data about a motion picture sequence. In particular, a reference frame (i.e., a frame of image occurring at some instant of time in a motion picture sequence) and motion from the reference frame are expressed as vectors. In terms of dimensions, a motion vector is a position (usually, expressed in terms of number of pixels) and indicates the mount of motion.

Detection of motion vectors is used for frame rate (the number of frames of image per second) conversion, interlace-to-progressive conversion, and image compression processing which are performed in digital signal processing in an image display device. In the interlaced scanning, a complete picture is created by odd- and even-numbered scanning lines which are obtained by two scans. In the progressive scanning, a complete picture is obtained by one scan.

Motion vectors are determined from the degrees of match calculated about candidate vectors for the motion vectors established in the aforementioned search area. Generally, the sum of absolute differences (SAD) is used as the degree of match.

Heretofore, proposals on improvements on the technique for detecting motion vectors at image boundaries have been made to be able to accurately predict blocks located at the boundaries of active blocks. In such a proposal, blocks that may produce inaccurate motion vectors are judged. These blocks are replaced by row motion vectors or column motion vectors determined based on the previous image (see, for example, patent reference 1 (JP-A-2005-287048)).

The technique disclosed in the above-cited patent reference 1 (JP-A-2005-287048) is intended to prevent detection of inaccurate motion vectors (such as erroneously detected motion vectors or motion vectors forcibly corrected in the zero-direction). In the classical method of detecting motion vectors, only matching between two frames is used and so motion vectors indicating the outside of (the frames of) image cannot be detected. In contrast, according to the technique disclosed in the above-cited patent reference 1 (JP-A-2005-287048), motion of every block in a certain image can be detected reliably, and deterioration of the interpolation algorithm at the boundary between active images can be prevented effectively.

The technique disclosed in the above-cited patent reference 1 (JP-A-2005-287048) adopts a technique of replacing inaccurate motion vectors by information about motion vectors in the previous frame of image (past frame of image) regarding edge regions of the image where inaccurate motion vectors as described above tend to be detected when motion vectors are detected from images.

However, where the above-described technique is adopted, it cannot be always said that motion vectors determined based on information about motion vectors in past frames of image are effectively used as motion vectors in the presently noticed frame. Therefore, in the technique disclosed in the above-cited patent reference 1 (JP-A-2005-287048), it is difficult to detect accurate motion vectors at edge regions of the frame of image where inaccurate motion vectors tend to be detected.

### SUMMARY OF THE INVENTION

Accordingly, it is an object of the present invention to provide a technique enabling accurate motion vectors to be detected even from edge regions in a frame of image where inaccurate motion vectors would normally tend to be detected in a case where motion vectors are detected from between a frame of image displayed in the past and the presently displayed frame of image.

A vector detection apparatus according to one aspect of the present invention finds motion vectors from an input image signal in a digital format and has: a first image signal delaying and outputting unit which outputs the image signal with a delay of a period of one frame with respect to the input image signal by holding the image signal entered from the outside; a second image signal delaying and outputting unit which outputs the image signal with a delay of a period of one frame with respect to the image signal entered to the second image signal delaying and outputting unit by holding the image signal from the first image signal delaying and outputting unit; a third image signal delaying and outputting unit which outputs the image signal with a delay of a period of one frame with respect to the image signal entered to the third image signal delaying and outputting unit by holding the image signal from the second image signal delaying and outputting unit; and a motion vector-detecting unit which performs given processing to detect motion vectors, using a frame of the image signal entered directly from the outside via none of the first through third image signal delaying and outputting units as well as frames of the image signals respectively entered from the first through third image signal delaying and outputting units in synchronism with the frame of the image signal entered directly from the outside.

In a preferred embodiment associated with the first aspect of the present invention, the given processing performed by the motion vector-detecting unit is calculation of the interframe correlation in the image signal. The calculation of the interframe correlation is performed about each of the frame of the image signal entered directly from the outside and the frames of the image signals from the first through third image signal delaying and outputting units entered in synchronism with the frame of the image signal directly entered from the outside.

In another embodiment, the calculation of the interframe correlation is performed (i) between the frame of the image signal directly entered from the outside and the frame of the image signal from the first image signal delaying and outputting unit, (ii) between the frame of the image signal from the first image signal delaying and outputting unit and the frame of the image signal from the second image signal delaying and outputting unit, or (iii) between the frame of the image signal from the second image signal delaying and outputting unit and the frame of the image signal from the third image signal delaying and outputting unit.

In a further embodiment, there are further provided a past vector-detecting unit and a motion vector delaying and outputting unit. The past vector-detecting unit performs processing for finding the rates of appearance of motion vectors in one frame outputted from the motion vector-detecting unit. Furthermore, the past vector-detecting unit performs processing for taking a given number of motion vectors as past vectors from the motion vector with the highest rate of appearance in turn. The motion vector delaying and outputting unit holds the past vectors outputted from the past vector-detecting unit to thereby output the past vectors to the motion vector-detecting unit with a delay of a period of one frame with respect to the past vectors entered to the motion vector delaying and outputting unit.

In a still other embodiment, the motion vector-detecting unit performs the calculation of the interframe correlation about a region surrounding the four corners of each of frames including the frames of the image signals outputted from the first through third image signal delaying and outputting units and the frame of the image signal directly entered from the outside while regarding even the past vectors outputted from the past vector-detecting unit as candidates for motion vectors.

In an additional embodiment, computational processing performed by the motion vector-detecting unit to detect the motion vectors includes at least first through fifth process steps. In the first process step, a frame (hereinafter may be referred to as the detection frame) is established between the frame of the image signal from the first image signal delaying and outputting unit and the frame of the image signal from the second image signal delaying and outputting unit to detect motion vectors. In the second process step, plural straight lines passing through the frame of the image signal entered directly from the outside and through the frames of the image signals outputted from the first through third image signal delaying and outputting units are established, using certain pixels in the detection frame as a reference. In the third process step, the differences between the pixels in the frame of the image signal directly entered from the outside and existing on the plural straight lines and the pixels in the frame of the image signal from the first image signal delaying and outputting unit, the differences between the pixels in the frame of the image signal from the first image signal delaying and outputting unit and existing on the straight lines and the pixels in the frame of the image signal from the second image signal delaying and outputting unit, and the differences between the pixels in the frame of the image signal from the second image signal delaying and outputting unit and existing on the straight lines and the pixels in the frame of the image signal from the third image signal delaying and outputting unit are found. In the fourth process step, a sum value of the differences found in the third process step is found, and the sum value is taken as points for each of the straight lines. In the fifth process step, one of the straight lines which has the least point is used as a reference in determining motion vectors.

In a yet further embodiment, in a case where the differences cannot be found from any one of the plural straight lines in the third process step, the differences that cannot be found are neglected. The found differences are corrected.

In a still additional embodiment, in a case where the differences cannot be found by the motion vector-detecting unit from any one of the plural straight lines in the third process step, appropriate points are given to one of the straight lines which is indicated by the past vectors from the past vector-detecting unit. The calculation of the interframe correlation is performed, using even the straight line to which the points are given as a candidate for a motion vector.

In a yet additional embodiment, there are further provided a first low-pass filter connected between the input side of the motion vector-detecting unit and an image signal input unit enabling the image signal from the outside to be entered to remove High frequency components included in the image signal, a first information-reducing unit acting to reduce the amount of information of the image signal outputted from the first low-pass filter, and a fourth image signal delaying and outputting unit acting to output the image signal with a delay of a period of one frame with respect to the entered image signal by holding the image signal outputted from the first information-reducing unit.

In an additional embodiment, there is further provided a fifth image signal delaying and outputting unit connected between the input side of the first image signal delaying and outputting unit and the image signal input unit to delay the image signal with a delay of a period of one frame with respect to the entered image signal by holding the image signal from the image signal input unit.

In an additional embodiment, there are provided a second low-pass filter connected between the output side of the third image signal delaying and outputting unit and the input side of the second image signal delaying and outputting unit to remove RF components included in the image signal and a second information-reducing unit acting to reduce the amount of information of the image signal outputted from the second low-pass filter.

In an additional embodiment, the third and fourth image signal delaying and outputting units have capacities set smaller than capacities of the first, second, and fifth image signal delaying and outputting units.

In an additional embodiment, two kinds of reduction, i.e., reduction of the amount of information of the image signal entered from the image signal input unit through the first low-pass filter by the first information-reducing unit and reduction of the amount of information of the image signal entered from the image signal input unit through the second low-pass filter and through the second, first, and fifth image signal delaying and outputting units by the second information-reducing unit, are carried out about a rectangular region of the frame of each of these image signals except for outer edge regions having a given width.

A vector detecting method according to a second aspect of the present invention is used to find motion vectors from an image signal in a digital format and involves the steps of: holding an image signal entered from the outside to thereby output the image signal with a delay of a period of one frame with respect to the entered image signal (first step); holding the image signal outputted through the first step to thereby output the image signal with a delay of a period of one frame with respect to the entered image signal (second step); holding the image signal outputted through the second step to thereby output the image signal with a delay of a period of one frame with respect to the entered image signal (third step); and detecting motion vectors by performing given processing using various frames including the frame of the image signal entered directly from the outside via none of the first through third steps and the frames of the image signals outputted via the first through third steps, respectively, in synchronism with the frame of the image signal entered directly from the outside (fourth step).

An image display device according to a third aspect of the present invention has: an image signal-extracting device which extracts an image signal in a desired digital format from a received image signal; a motion vector-detecting device which finds motion vectors from the image signal in the digital format extracted by the image signal-extracting device; and a frame rate & interlace-progressive converter which performs a frame rate conversion or an interlace-progressive conversion on the image signal in the digital format extracted by the image signal-extracting device, based on the motion vectors outputted from the motion vector-detecting device. The motion vector-detecting device has: a first image signal delaying and outputting unit which outputs the image signal with a delay of a period of one frame with respect to the entered image signal by holding the image signal entered from the image signal-extracting device; a second image signal delaying and outputting unit which outputs the image signal with a delay of a period of one frame with respect to the image signal entered to the second image signal delaying and outputting unit by holding the image signal entered from the first image signal delaying and outputting unit; a third image signal delaying and outputting unit which outputs the image signal with a delay of a period of one frame with respect to the image signal entered to the third image signal delaying and outputting unit by holding the image signal entered from the second image signal delaying and outputting unit; and a motion vector-detecting unit which performs given processing to detect motion vectors, using various frames including the frame of the image signal entered directly from the image signal-extracting device via none of the first through third image signal delaying and outputting units and the frames of the image signals entered respectively from the first through third image signal delaying and outputting units in synchronism with the frame of the image signal entered directly from the image signal-extracting device.

According to the present invention, in a case where motion vectors are detected between two frames of image which are successive in time, accurate motion vectors can be detected even from edge regions of a frame of image where inaccurate motion vectors would normally tend to be detected.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the whole configuration of a motion vector detection apparatus according to one embodiment of the present invention.

FIG. 2 is a diagram illustrating one example of matching technique implemented when motion vectors are detected by a motion vector-detecting portion shown in FIG. 1.

FIG. 3 is a diagram illustrating the matching technique illustrated in FIG. 2, and in which it is impossible to perform processing for calculating the absolute values of the differences between pixels indicated by plane coordinates in frames of image.

FIG. 4 is a diagram illustrating regions to which the matching technique illustrated in FIG. 2 is applied and regions to which another matching technique is applied, the regions being included in frames necessary to detect motion vectors.

FIG. 5 is a diagram illustrating a transition of an image signal between frames, the image signal being displayed and outputted through a motion vector detection apparatus associated with one embodiment of the present invention.

FIG. 6 is a diagram illustrating a transition of an image signal between frames, the image signal being displayed and outputted in a case where a related-art, classical motion vector detection method is used.

FIG. 7 is a block diagram showing the whole configuration of a motion vector detection apparatus associated with another embodiment of the present invention.

FIG. 8 is a diagram showing regions of a 2-frames-later frame reduced by a first image information-reducing portion of the motion vector detection apparatus shown in FIG. 7 and regions of a 2-frames-earlier frame reduced by a second image information-reducing portion.

FIGS. 9A and 9B are schematic diagrams illustrating matching processing performed by the motion vector-detecting portion of the motion vector detection apparatus shown in FIG. 7 to detect motion vectors, using the 2-frames-earlier frame whose amount of information has been reduced to a one-ninth.

FIG. 10 is a functional block diagram showing the configuration of an image display device incorporating a motion vector detection apparatus associated with the present invention.

### DETAILED DESCRIPTION OF THE EMBODIMENTS

Embodiments of the present invention are hereinafter described in further detail with reference to the drawings.

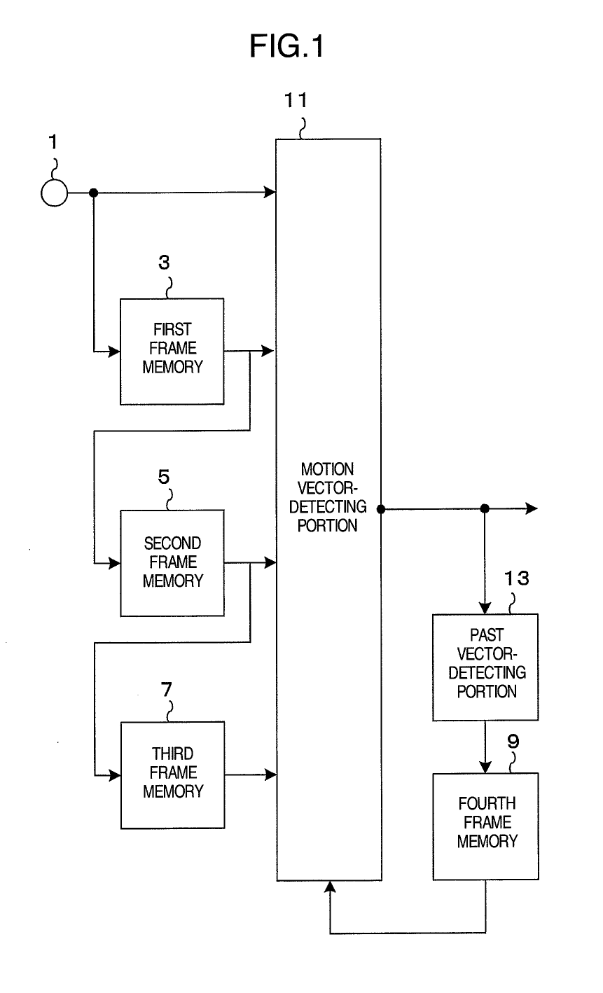

FIG. 1 is a block diagram showing the whole configuration of a motion vector detection apparatus associated with one embodiment of the present invention. The motion vector detection apparatus is built, for example, in an image display device such as a digital TV receiver.

The motion vector detection apparatus is designed to perform given signal processing while receiving an image signal as its input signal, the signal being exclusively in a digital format. Therefore, where an image signal in an analog format is supplied as the input signal to the image display device, the image signal is converted into a digital format by an analog-to-digital converter portion equipped in the image display device and then entered into the motion vector detection apparatus. As shown in FIG. 1, the motion vector detection apparatus has a signal input portion 1, plural frame memories (i.e., first frame memory 3, second frame memory 5, third frame memory 7, and fourth frame memory 9), a motion vector-detecting portion 11, and a past vector-detecting portion 13.

An image signal entered into the motion vector detection apparatus through the signal input portion 1 is outputted to the first frame memory 3 and to the motion vector-detecting portion 11.

Each of the first frame memory 3, second frame memory 5, third frame memory 7, and fourth frame memory 9 is designed to hold one frame of the input signal to thereby output the held image signal with a delay of a period of one frame with respect to the entered signal.

The first frame memory 3 delays the image signal entered through the signal input portion 1 by a period of one frame with respect to the image signal directly outputted to the motion vector-detecting portion 11 from the signal input portion 1 and outputs the delayed signal to the second frame memory 5 and to the motion vector-detecting portion 11.

The second frame memory 5 delays the image signal, which has been delayed by a period of one frame by the first frame memory 3 with respect to the image signal from the signal input portion 1, by a period of one frame and outputs the further delayed signal to the third frame memory 7 and to the motion vector-detecting portion 11. That is, the image signal outputted from the second frame memory 5 is delayed by a period of two frames with respect to the image signal directly outputted to the motion vector-detecting portion 11 from the signal input portion 1.

The third frame memory 7 delays the image signal, which has been delayed by a period of two frames in total by the actions (or one frame by each action) of the first frame memory 3 and the second frame memory 5 with respect to the image signal from the signal input portion 1, by a period of one frame and outputs the still further delayed signal to the motion vector-detecting portion 11. That is, the image signal outputted from the third frame memory 7 is delayed by a period of three frames with respect to the image signal directly outputted from the signal input portion 1 to the motion vector-detecting portion 11.

The motion vector-detecting portion 11 reads in the image signals entered through the first frame memory 3, second frame memory 5, and third frame memory 7, respectively, as well as the image signal directly entered from the signal input portion 1. The detecting portion 11 performs processing for detecting motion vectors, based on the four frames in total entered into the motion vector-detecting portion 11 in synchronism out of the frames constituting the image signals. That is, the motion vector-detecting portion 11 detects vectors produced between the image signal outputted from the first frame memory 3 and delayed by a period of one frame with respect to the image signal from the signal input portion 1 and the image signal outputted from the second frame memory 5 and delayed by a period of two frames with respect to the image signal from the signal input portion 1 as motion vectors.

An interpolation frame-creating portion (not shown) for creating an interpolation frame located midway between the current frame on the time axis and a frame immediately preceding the current frame is connected with the motion vector-detecting portion 11. The interpolation frame is necessary to detect the motion vectors. Creation of interpolation frames by the interpolation frame-creating portion (not shown) is triggered by application of an enable signal for creation of interpolation frames to the interpolation frame-creating portion (not shown). For example, the enable signal is created by an interpolation enable creation portion (not shown).

The frame from the second frame memory 5, i.e., the frame delayed by a period of two frames with respect to the image signal from the signal input portion 1, is placed in a position earlier than the interpolation frame created by the interpolation frame-creating portion (not shown) connected with the motion vector-detecting portion 11, based on the frame delayed by a period of two frames and on the frame from the first frame memory 3, i.e., the frame delayed by a period of one frame with respect to the image signal from the signal input portion 1. Therefore, in the following description, the frame from the second frame memory 5 is conveniently referred to as the 1-frame-earlier frame or simply as the earlier frame. The frame from the third frame memory 7, i.e., the frame delayed by a period of three frames with respect to the image signal from the signal input portion 1, is located earlier than the earlier frame and located two frames earlier than the interpolation frame. Therefore, in the following description, the frame from the third frame memory 7 is conveniently referred to as the 2-frames-earlier frame.

Meanwhile, the frame from the first frame memory 3, i.e., the frame delayed by a period of one frame with respect to the image signal from the signal input portion 1, is located later than the interpolation frame. Therefore, in the following description, the frame from the first frame memory 3 is conveniently referred to as the 1-frame-later frame or simply as the later frame. The non-delayed frame that is directly entered from the signal input portion 1 to the motion vector-detecting portion 11 is located later than the later frame and located two frames later than the interpolation frame. Therefore, in the following description, the frame from the signal input portion 1 is conveniently referred to as the 2-frames-later frame.

The aforementioned 2-frames-later frame, 1-frame-later frame, 1-frame-earlier frame, and 2-frames-earlier frame are arranged in the direction of flow of time, i.e., the four frames are arranged on the time axis in this order.

The detection of the motion vectors by the motion vector-detecting portion 11 is performed for all the pixels forming the later frame and the earlier frame. For example, where each one of frames of image (e.g., the later frame and earlier frame) is made up of 640×480 pixels, the operation for detecting motion vectors is repeated the number of times equal to the value of this product.

The motion vector-detecting portion 11, past vector-detecting portion 13, and fourth frame memory 9 together form a feedback loop for feeding motion vectors about one frame of image detected by the motion vector-detecting portion 11 back to the motion vector-detecting portion 11.

The past vector-detecting portion 13 inputs motion vectors about one frame from the motion vector vector-detecting portion 11. Based on the motion vectors about the one frame, the detecting portion 13 performs processing for detecting motion vectors representing the overall tendency of the motion vectors about the one frame. The past vector-detecting portion 13 outputs the detected one or more motion vectors to the fourth frame memory 9.

The fourth frame memory 9 delays the motion vector or vectors outputted from the past vector-detecting portion 13 by a period of one frame with respect to the motion vector or vectors outputted from the motion vector-detecting portion 11, and outputs the delayed vectors to the motion vector-detecting portion 11. Therefore, the motion vector or vectors outputted from the fourth frame memory 9 to the motion vector-detecting portion 11 are motion vectors produced one frame earlier than the motion vectors directly outputted from the motion vector-detecting portion 11. Consequently, the motion vector or vectors outputted from the past vector-detecting portion 13 to the fourth frame memory 9 are referred to as past vector(s).

The past vectors are fed back to the motion vector-detecting portion 11 from the motion vector-detecting portion 11 through the past vector-detecting portion 13 and fourth frame memory 9 and are detected from within one frame. The number of these past vectors is appropriately set. The fourth frame memory 9 needs to have a sufficient storage capacity to store the past vectors.

The motion vectors which are detected by the motion vector-detecting portion 11 are outputted to the past vector-detecting portion 13 and to the interpolation frame-creating portion (not shown).

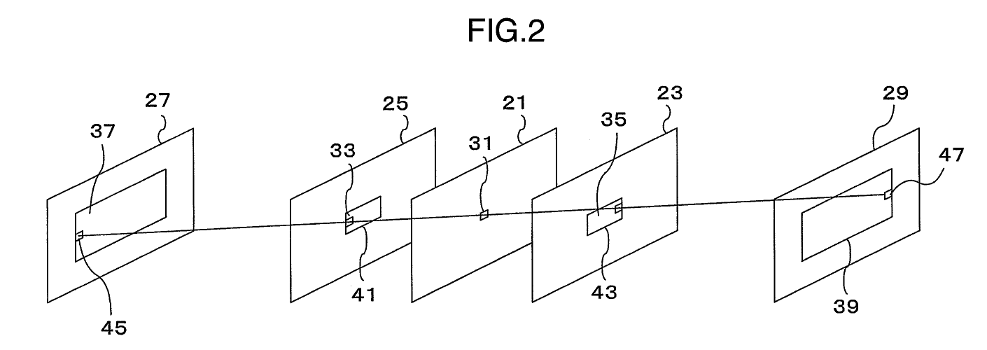

FIG. 2 is a diagram illustrating one example of matching technique used when the motion vector-detecting portion 11 shown in FIG. 1 detects motion vectors.

In FIG. 2, a frame 21 is used to detect motion vectors, and corresponds to the above-described interpolation frame created by the interpolation frame-creating portion (not shown). A frame 23 is outputted from the first frame memory 3 to the motion vector-detecting portion 11 and located later than the interpolation frame 21 by a period of one frame, and hence corresponds to the later frame. A frame 25 is outputted from the second frame memory 5 to the motion vector-detecting portion 11 and located earlier than the interpolation frame 21 by a period of one frame. Therefore, this frame 25 corresponds to the earlier frame.

A frame 27 is outputted from the third frame memory 7 to the motion vector-detecting portion 11 and located earlier than the interpolation frame 21 by a period of two frames and hence corresponds to the 2-frames-earlier frame. A frame 29 is directly outputted from the signal input portion 1 to the motion vector-detecting portion 11 and located later than the interpolation frame 21 by a period of two frames. Therefore, the frame 29 corresponds to the 2-frames-later frame.

In the interpolation frame 21 used to detect motion vectors, a motion vector detection position 31 is determined by scanning within the interpolation frame 21 by the motion vector-detecting portion 11. The motion vector-detecting portion 11 establishes a correlation search window for the motion vector detection position 31 by a technique described later regarding each of the frames including the later frame 23, earlier frame 25, 2-frames-earlier frame 27, and 2-frames-later frame 29 excluding the interpolation frame 21.

In particular, the motion vector-detecting portion 11 sets the correlation search window 33 having a range of (2M+1) pixels wide and (2N+1) pixels high about the position corresponding to the motion vector detection position 31 within the earlier frame 25, regarding the earlier frame 25. M and N are natural numbers. Similarly, the detecting portion 11 sets a correlation search window 35 having a range of (2M+1) pixels wide and (2N+1) pixels high about the position corresponding to the motion vector detection position 31 within the later frame 23, regarding the later frame 23. It is assumed here that M=2 and N=1.

Furthermore, the motion vector-detecting portion 11 sets a correlation search window 37 having a range of (6M+1) pixels wide and (6N+1) pixels high about the position corresponding to the motion vector detection position 31 within the 2-frames-earlier frame 27, regarding this 2-frames-earlier frame 27. Similarly, the detecting portion 11 sets a correlation search window 39 having a range of (6M+1) pixels wide and (6N+1) pixels high about the motion vector detection position 31 within the 2-frames-later frame 29, regarding this frame 29. It is also assumed that M=2 and N=1.

The motion vector detection position 31 in the interpolation frame 21 is indicated by plane coordinates (0, 0). Also, plural straight lines passing through the motion vector detection position 31 and through the correlation search windows 33, 35, 37, and 39 are established. In the present embodiment, the following 15 straight lines (a)-(o) are established as the above-described straight lines.

(a) 27(−6,3)−25(−2,1)−23(2,−1)−29(6,−3)

(b) 27(−3,3)−25(−1,1)−23(1,−1)−29(3,−3)

(c) 27(0,3)−25(0,1)−23(0,−1)−29(0,−3)

(d) 27(3,3)−25(−1,1)−23(−1,−1)−29(−3,−3)

(e) 27(6,3)−25(−2,1)−23(2,−1)−29(−6,−3)

(f) 27(−6,0)−25(−2,0)−23(2,0)−29(6,0)

(g) 27(−3,0)−25(−1,0)−23(1,0)−29(3,0)

(h) 27(0,0)−25(0,0)−23(0,0)−29(0,0)

(i) 27(3,0)−25(−1,0)−23(1,0)−29(−3,0)

(j) 27(6,0)−25(−2,0)−23(2,0)−29(−6,0)

(k) 27(−6,−3)−25(−2,−1)−23(2,1)−29(6,3)

(l) 27 (−3,−3)−25(−1,−1)−23(1,1)−29(3,3)

(m) 27(0,−3)−25(0,−1)−23(0,1)−29(0,3)

(n) 27(3,−3)−25(−1,−1)−23(1,1)−29(−3,3)

(o) 27(6,−3)−25(−2,−1)−23(2,1)−29(−6,3)

The line (a) of the 15 straight lines is described. The straight line (a) passes through the position indicated by the plane coordinates (−6,3) in the 2-frames-earlier frame 27. The line (a) passes through the position indicated by the plane coordinates (−2,1) in the earlier frame 25. The line (a) passes through the position indicated by the plane coordinates (2,−1) in the later frame 23. The line (a) passes through the position indicated by the plane coordinates (6,−3) in the 2-frames-later frame 29. The other straight lines (b)-(o) pass through the positions indicated by the plane coordinates in the 2-frames-earlier frame 27, the positions indicated by the plane coordinates in the earlier frame 25, the positions indicated by the plane coordinates in the later frame 23, and the positions indicated by the plane coordinates in the 2-frames-later frame 29, in the same way as in the case of the straight line (a). All the 15 straight lines pass through the motion vector detection position 31 but description of 21 (0,0) is omitted. The 15 straight lines pass through the pixel in the position indicated by the plane coordinates in the 2-frames-earlier frame 27, the pixel in the position indicated by the plane coordinates in the earlier frame 25, the pixel in the position indicated by the plane coordinates in the later frame 23, and the pixel in the position indicated by the plane coordinates in the 2-frames-later frame 29.

The motion vector-detecting portion 11 performs given computational processing to find parameters regarding the correlations of the 15 straight lines with the motion vector detection position 31. That is, the detecting portion 11 finds the absolute value of the difference between the pixel 41 in the position indicated by the plane coordinates (−X, −Y) in the correlation search window 33 in the earlier frame 25 and the pixel 43 in the position indicated by the plane coordinates (X, Y) in the correlation search window 35 in the later frame 23. Furthermore, the motion vector-detecting portion 11 finds the absolute value of the difference between the pixel 41 in the earlier frame 25 and the pixel 45 in the position indicated by the plane coordinates (−3X, −3Y) in the correlation search window 37 in the 2-frames-earlier frame 27. In addition, the detecting portion 11 finds the absolute value of the difference between the pixel 43 in the later frame 23 and the pixel 47 in the position indicated by the plane coordinate (3X, 3Y) in the correlation search window 39 within the 2-frames-later frame 29.

Then, the motion vector-detecting portion 11 scans through the correlation search window 35 in the later frame 23 from −M to M in the X-direction (X-axis direction in plane coordinates) and from −N to N in the Y-direction (Y-axis direction in plane coordinates). Thus, the detecting portion 11 performs the computational processing for finding the absolute values of the differences between pixels indicated by plane coordinates in the correlation search window for each frame regarding each of the 15 straight lines by performing the above-described scanning. The sum of the absolute values of the differences is calculated for each of the straight lines and used as points given to each straight line.

Where the absolute values of the differences cannot be computed because any of the positions indicated by the plane coordinates deviates from the ranges of the frames 23, 25, 27, 29, the motion vector-detecting portion 11 corrects the points given to the straight lines, using rules described below. (1) Where the absolute value of the difference that cannot be calculated is one in number, the remaining absolute values of differences are multiplied by a factor of 1.5. (2) Where the absolute values of the differences that cannot be calculated are two in number, the remaining absolute values of differences are multiplied by a factor of 3. The sum of the absolute values of the differences is taken as points for the corresponding straight line.

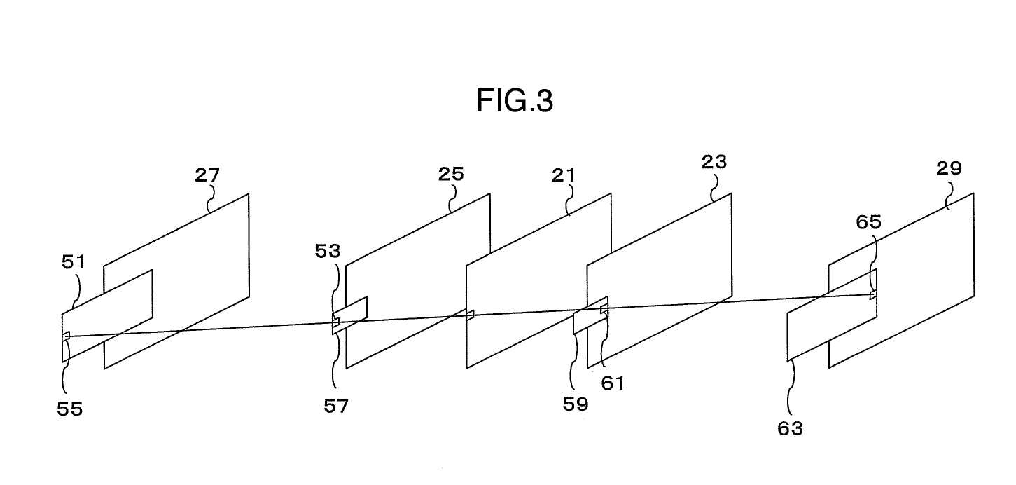

FIG. 3 is a diagram illustrating one example of a case in which it is impossible to perform the processing for calculating the absolute values of the differences between pixels indicated by plane coordinates in frames by the matching technique illustrated in FIG. 2.

In the example illustrated in FIG. 3, the pixel 55 in the correlation search window 51 for the 2-frames-earlier frame 27 is outside the 2-frames-earlier frame 27. The pixel 57 in the correlation search window 53 for the earlier frame 25 is outside the earlier frame 25. Therefore, with respect to a pixel 61 in the correlation search window 59 not deviating from the later frame 23 and a pixel 65 in the correlation search window 63 not deviating from the 2-frames-later frame 29, the motion vector-detecting portion 11 performs processing for tripling the absolute values of the difference between the two pixels, and takes the tripled absolute value of the difference as points for the straight line passing through the pixels 55, 57, 61, and 65.

The distribution among the magnification factors by which the absolute values of differences are corrected may be modified taking account of the reliability obtained when matching is done. With respect to the points given to the straight lines, as their values are reduced, the lines are judged to lie in directions having higher correlations, i.e., judged as motion vectors. As described previously, in the present embodiment, the values of M and N for determining the size of the correlation detection windows are set to 2 and 1, respectively. These are arbitrary values and can be set to appropriate values, depending on the effects of the interpolation, the amount of computation performed by the motion vector-detecting portion 11, the circuit scale of the motion vector-detecting portion 11, and other factors. For example, if M=7 and N=3, the number of the above-described straight lines is 105.

A matching technique different from the matching technique illustrated in FIG. 2 is next described.

In the matching technique described now, the motion vector-detecting portion 11 first calculates the absolute values of differences for each of straight lines drawn to pass through correlation search windows established in the various frames (the aforementioned 2-frames-earlier frame, earlier frame, later frame, and 2-frames-later frame) and from correlation search window to correlation search window, in the same way as in the above-described matching technique. The absolute values of differences that could be calculated are corrected according to the number of the absolute values of differences that could not be computed.

Then, the motion vector-detecting portion 11 gives appropriate points to any one of the straight lines indicated by past vectors which are given through the past vector-detecting portion 13 and fourth frame memory 9. The appropriate points are set to values selected when the points given to the plural straight lines do not contain extremely low points. In other words, the appropriate values are selected when the straight lines do not contain lines which are obviously matched. Where points have been already given to any of the straight lines by calculations of the absolute values of differences, the processing for giving points using the past vectors may be omitted.

In this matching technique, as the values of the points are reduced, the motion vector-detecting portion 11 judges straight lines to which the points are given to lie in directions having higher correlations, i.e., judges them as motion vectors, in the same way as the above-described matching technique.

In this matching technique, the values of M and N for determining the size of each correlation search window is set to arbitrary values of 2 and 1, respectively (M=2 and N=1), in the same way as in the above-described matching technique.

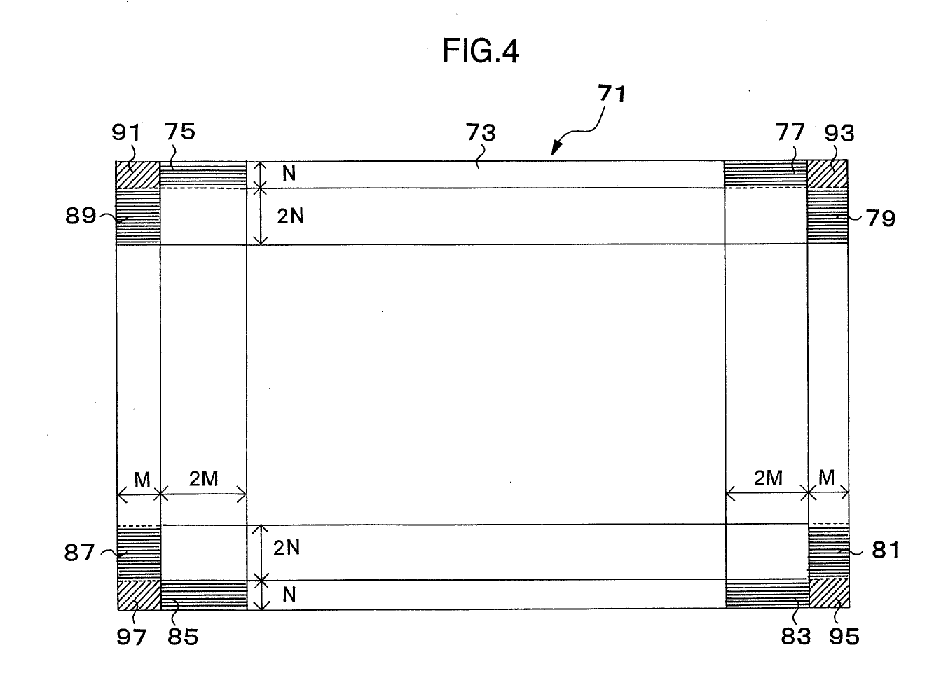

FIG. 4 is a diagram illustrating various regions of the frames necessary for detection of motion vectors. The various regions include regions to which the matching technique illustrated in FIG. 2 is applied and regions to which a different matching technique is applied.

Referring to FIG. 4, a frame 71 corresponds to the interpolation frame 21 shown in FIG. 2, the frame 21 being used to detect motion vectors. The frame 71 is divided into regions 73, 75, 77, 79, 81, 83, 85, 87, and 89 and regions 91, 93, 95, and 97. In the following description, the region 73 is referred to as the first region. The regions 75-89 are referred to as the second regions. The regions 91-97 are referred to as the third regions. The sizes of all of these regions 73-97 are determined by the values of M and N that determine the sizes of the correlation search windows. That is, the sizes of the regions 73-97 depend on the sizes of the correlation search windows 41 and 43 shown in FIG. 2 and on the sizes of the correction search windows 57 and 59 shown in FIG. 3. In other words, the regions 73-97 described above correspond to the correlation search windows.

The aforementioned regions 73-97 are shown in the following form:

(A) 73—(M, N)−(W−M, H−N)

(B) 75—(M, 0)−(3M, N)

(C) 77—(W−3M, 0)−(W−M, N)

(D) 79—(W−M, N)−(W, 3N)

(E) 81—(W−M, H−3N)−(W, H−N)

(F) 83—(W−3M, H−N)−(W−M, H)

(G) 85—(M, H−N)−(3M, H)

(H) 87—(0, H−3N)−(M, H−N)

(I) 89—(0, N)−(M, 3N)

(J) 91—(0, 0)−(M, N)

(K) 93—(W−M, 0)−(W, N)

(L) 95—(W−M, H−N)−(W, H)

(M) 97—(0, H−N)−(M, H)

The region (A) that is a window for correlation search and included in the above-described 13 regions (windows for correlation search) is described. Symbol 73 is attached to the correlation search window (A). (M, N) indicates the plane coordinates (X, Y) of the left upper corner of the correlation search window (A). (W−M, H−N) indicates the plane coordinates of the right lower corner in the correlation search window (A). At the plane coordinates of the right lower corners, W indicates the number of pixels in the lateral direction in the correlation search window (A). H indicates the number of pixels in the vertical direction of the correlation search window (A). With respect to the remaining regions (correlation search windows (B)-(M)), similar symbols are given to the correlation search windows. Also, the plane coordinates (X, Y) of the left upper corners of the correlation search windows are shown. Furthermore, the plane coordinates of the right lower corners of the correlation search windows are shown.

Preferably, motion vectors are detected from the first region 73 by the matching technique illustrated in FIG. 2, and motion vectors are detected from the second and third regions (75-89 and 91-97) by the aforementioned second matching technique. Alternatively, matching may not be done in the whole second region (75-89) but those of the plural straight lines which are indicated by past vectors may be regarded as detected motion vectors. Yet alternatively, matching may not be done in the whole third region (91-97) but zero-direction vectors may be regarded as detected motion vectors.

The matching technique used in the second and third regions is not limited to the above-described form. The technique may be appropriately determined according to desired image quality of image signals and the circuit scale of the actually used apparatus.

Processing performed by the aforementioned past vector-detecting portion 13 is next described.

In the present embodiment, the past vector-detecting portion 13 first performs processing for finding a histogram of motion vectors about one frame outputted from the motion vector-detecting portion 11, i.e., the rates of appearance of the individual motion vectors. During this processing for finding the histogram, it is desired not to take account of the motion vectors detected from the second and third regions. Then, the past vector-detecting portion 13 performs processing for arranging the motion vectors found as described above in order from the motion vector having the highest rate of appearance and determining an appropriate number of motion vectors as past vectors.

The technique for finding past vectors is not limited to the above-described technique. The number of past vectors to be found may be set at will. The method of determining past vectors may be appropriately determined according to desired image quality of image signals, the amount of computation performed by the actually used apparatus, or the circuit scale of the apparatus. For example, it is conceivable that motion vectors about one frame of image outputted from the motion vector-detecting portion 11 are averaged and used as a past vector. In this case, the past vector determined by the past vector-detecting portion 13 is one in number.

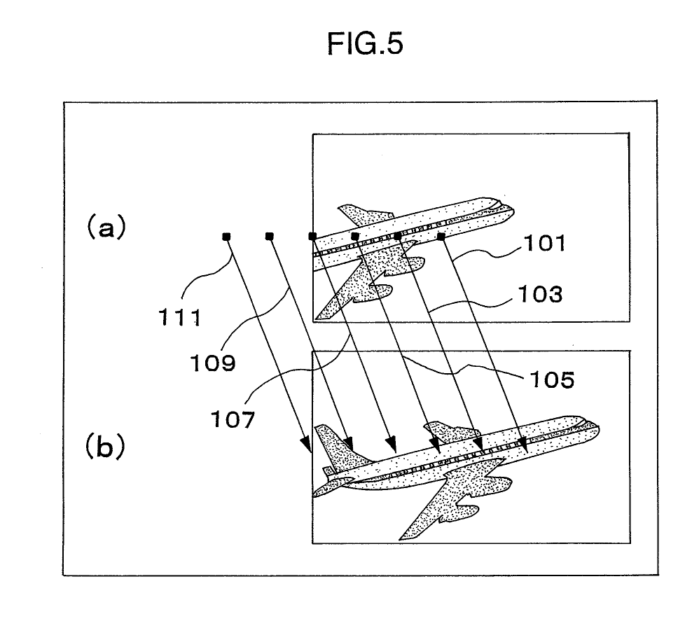

FIG. 5 is a diagram illustrating a transition of an image signal between frames, the image signal being displayed and outputted through a motion vector detection apparatus associated with one embodiment of the present invention.

In FIG. 5, plural motion vectors 101, 103, 105, 107, 109, and 111 which pass through the pixels in the present frame shown in (b) of FIG. 5 and through the corresponding pixels in the immediately preceding frame shown in (a) of FIG. 5 are all accurate motion vectors that are detected by the motion vector detection apparatus. It can be seen from (a) and (b) of FIG. 5 that images of a passenger jet airplane which are graphics contents are traveling to the right as viewed in FIG. 5 and therefore the motion vectors 101-111 are all directed to the right. Of the motion vectors described above, the motion vectors 109 and 111 indicate points located within the current frame. However, in the 1-frame-earlier frame, they indicate points located outside the frame.

In the 1-frame-earlier frame, the parts of the horizontal and vertical tails are absent in the image of the passenger jet airplane that is a graphics content. In the current frame, the image contains the horizontal and vertical tails. In the method of the above-described, related-art, classical method of detecting motion vectors, matching is done only between two frames to detect motion vectors and so the motion vectors 109 and 111 pointing to points located outside the frame as described previously could not be detected by this related-art method.

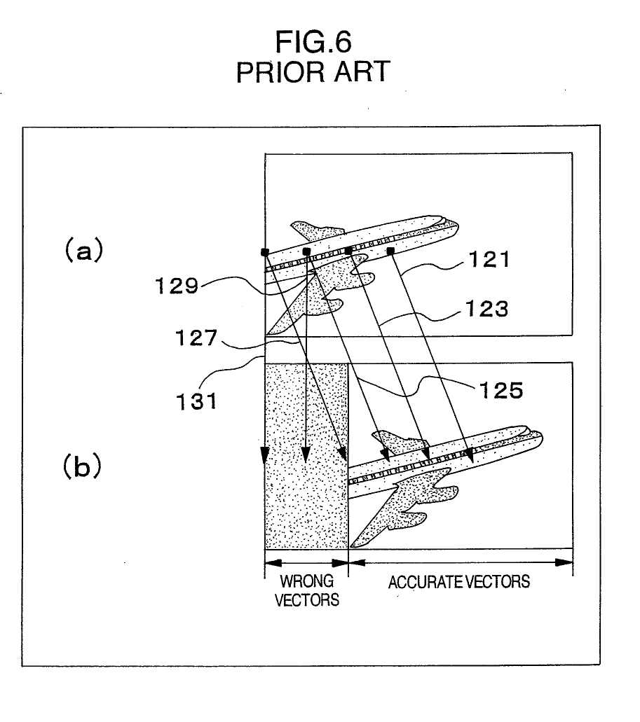

FIG. 6 is a diagram illustrating a transition of an image signal between frames, the image signal being displayed and outputted when the related-art, classical method of detecting motion vectors is used.

As described previously, in the related-art, classical method of detecting motion vectors, motion vectors are detected erroneously from edge regions of the frame or motion vectors forcibly corrected in the zero-direction (e.g., in the same direction as edge portions of the frame) are detected.

In FIG. 6, motion vectors extend from four pixels in the current frame shown in (b) of FIG. 6 toward the 1-frame-earlier frame shown in (a) of FIG. 6. Of these vectors, all of four motion vectors 121, 123, 125, and 127 are accurate motion vectors. Therefore, the graphics contents (image of the airplane in which the parts of the horizontal and vertical tails are absent) displayed in the 1-frame-earlier frame are also displayed in the current frame.

However, two motion vectors 129 and 131 which should be directed from outside the 1-frame-earlier frame in a direction parallel to the direction indicated by four motion vectors 121, 123, 125, and 127 are inaccurate motion vectors pointing to the same pixels as indicated by the motion vectors 125 and 127 in the 1-frame-earlier frame. In other words, the motion vectors 129 and 131 have been forcibly corrected in the zero direction.

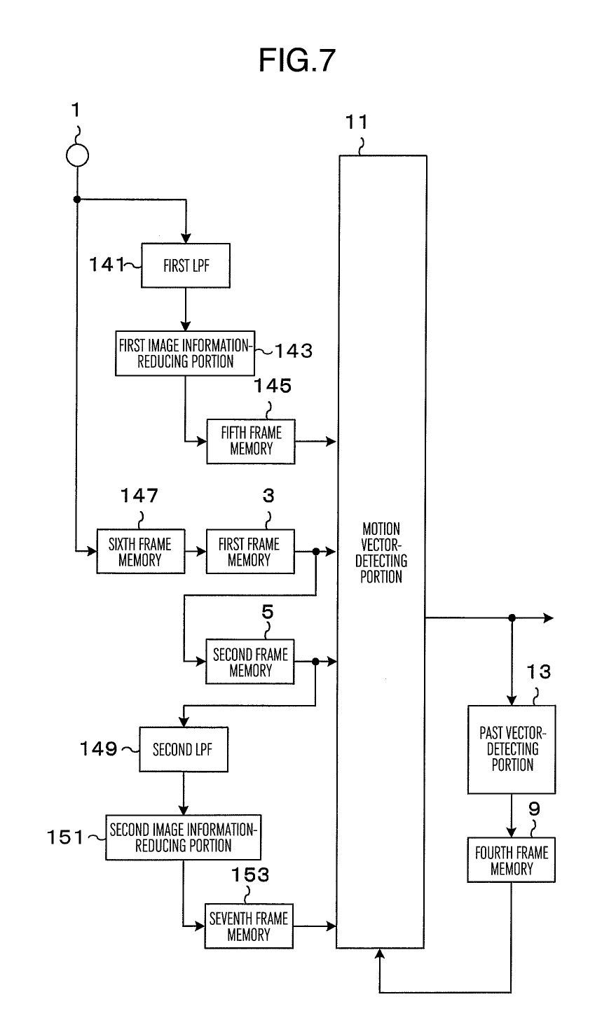

FIG. 7 is a block diagram showing the whole configuration of a motion vector detection apparatus associated with another embodiment of the present invention.

In the motion vector detection apparatus associated with the present embodiment, a first low-pass filter (hereinafter, referred to as first LPF) 141, a first image information-reducing portion 143, and a fifth frame memory 145 are connected with the signal line with which the signal input portion 1 and the input side of the motion vector-detecting portion 11 are directly connected. A sixth frame memory 147 is connected between the signal input portion 1 and the input side of the first frame memory 3. Furthermore, a second low-pass filter (hereinafter, referred to as second LPF) 149 and a second image information-reducing portion 151 are connected between the output side of the second frame memory 5 and the input side of a seventh frame memory 153, the memory 153 being connected instead of the third frame memory 7 shown in FIG. 1. The motion vector detection apparatus shown in FIG. 7 differs from the motion vector detection apparatus shown in FIG. 1 in these structural details.

The first low-pass filter 141 and second low-pass filter 149 are identical in structure and functions. The first image information-reducing portion 143 and second image information-reducing portion 151 are identical in structure and functions. The fifth frame memory 145 and seventh frame memory 153 are identical in structure and functions. The fifth frame memory 145 holds each frame of image from the first image information-reducing portion 143, the frame of image having a reduced amount of information. The seventh frame memory 153 holds each frame of image from the second image information-reducing portion 151, the frame of image having a reduced amount of information. Therefore, memories having a smaller storage capacity than that of the first and second frame memories 3 and 5 are used as the fifth frame memory 145 and the seventh frame memory 153. A memory having the same storage capacity as that of the first and second frame memories 3 and 5 is used as the sixth frame memory 147. The fifth, sixth, and seventh frame memories 145, 147, and 153 are designed to hold one frame of the input image signal to thereby output the held image signal with a delay of a period of one frame with respect to the input signal, in the same way as the first and second frame memories 3 and 5.

The motion vector detection apparatus shown in FIG. 7 is similar to the motion vector detection apparatus shown in FIG. 1 in other respects and so those components of FIG. 7 which are identical with their counterparts of FIG. 1 are indicated by the same reference numerals as in FIG. 1 and will not be described in detail below.

Referring to FIG. 7, an image signal entered to the motion vector detection apparatus through the signal input portion 1 is outputted to the first low-pass filter 141 and to the sixth frame memory 147. The first low-pass filter 141 receives the image signal from the signal input portion 1 and filters out RF components of the image signal. Then, the filter 141 outputs the signal to the first image information-reducing portion 143. The first image information-reducing portion 143 receives the image signal whose High frequency components have been filtered out from the first low-pass filter 141 and performs given processing on the image signal to reduce the amount of information of the image signal. Then, the information-reducing portion 143 outputs the signal to the fifth frame memory 145. The fifth frame memory 145 delays the image signal received via the first image information-reducing portion 143 by a period of one frame with respect to the image signal directly outputted from the signal input portion 1 to the motion vector-detecting portion 11, and outputs the delayed signal to the motion vector-detecting portion 11.

The sixth frame memory 147 delays the image signal entered via the signal input portion 1 by a period of one frame with respect to the image signal directly entered from the signal input portion 1 to the motion vector-detecting portion 11, and outputs the delayed signal to the first frame memory 3. The first frame memory 3 delays the image signal from the sixth frame memory 147, which has been already delayed by a period of one frame with respect to the image signal from the signal input portion 1, by a period of one frame, and outputs the further delayed signal to the second frame memory 5 and to the motion vector-detecting portion 11. That is, the image signal outputted from the first frame memory 3 is delayed by a period of two frames with respect to the image signal directly outputted from the signal input portion 1 to the motion vector-detecting portion 11.

The second low-pass filter 149 receives the image signal from the second frame memory 5 and filters out RF components of the image signal. The filter 149 outputs the signal to the second image information-reducing portion 151. The second image information-reducing portion 151 receives the image signal whose RF components have been filtered out from the second low-pass filter 149 and performs given processing on the image signal to thereby reduce the amount of information of the image signal. Then, the information-reducing portion 151 outputs the signal to the seventh frame memory 153. The seventh frame memory 153 delays the image signal entered through the second image information-reducing portion 151 by a period of four frames with respect to the image signal outputted directly from the signal input portion 1 to the motion vector-detecting portion 11, and outputs the delayed signal to the motion vector-detecting portion 11.

The motion vector-detecting portion 11 performs processing for detecting motion vectors, based on various frames including the frame delayed by a period of one frame and outputted from the fifth frame memory 145 with respect to the frame of the image signal directly outputted from the signal input portion 1 to the motion vector-detecting portion 11, the frame delayed by a period of two frames and outputted from the first frame memory 3, the frame delayed by a period of three frames and outputted from the second frame memory 5, and the frame delayed by a period of four frames and outputted from the seventh frame memory 153. The details of these processing operations for detecting motion vectors, the details of the processing operations performed by the past vector-detecting portion 13, and the details of the processing operations performed by the fourth frame memory 9 are the same as those of the operations already described in connection with FIG. 1 and so their description is omitted.

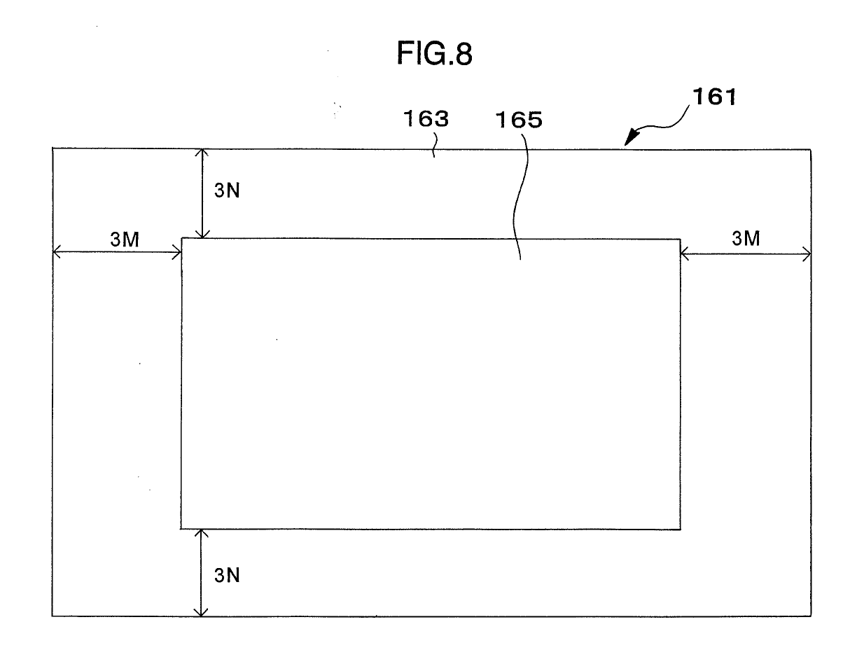

FIG. 8 is a diagram illustrating the region of the 2-frames-later frame 29 reduced by the first image information-reducing portion 143 in the motion vector detection apparatus shown in FIG. 7 and the region of the 2-frames-earlier frame 27 reduced by the second image information-reducing portion 151.

Referring to FIG. 8, in a frame 161 indicating the 2-frames-earlier frame 27 or the 2-frames-later frame 29, a region 163 is referenced by the motion vector-detecting portion 11 when matching is done to detect motion vectors. The region 163 forms an outer frame in the frame 161. The region 161 has a width of 3M in the vertical direction of the frame 161 and a width of 3N in the lateral direction of the frame 161. A rectangular region 165 surrounded by the region 163 is not always necessary when the above-described matching processing is performed. Therefore, where the frame 161 is the aforementioned 2-frames-earlier frame 27, the region 163 is deleted by the second image information-reducing portion 151. Where the frame 161 is the aforementioned 2-frames-later frame 29, the region 163 is deleted by the first image information-reducing portion 143.

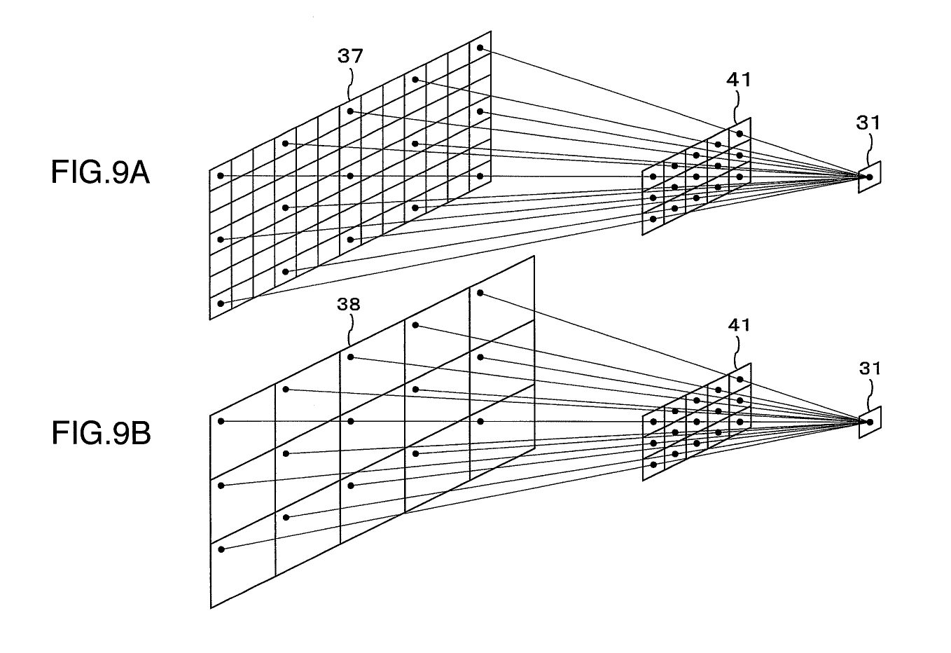

FIGS. 9A and 9B schematically illustrate matching processing performed by the motion vector-detecting portion 11 of the motion vector detection apparatus shown in FIG. 7 by the use of the 2-frames-earlier frame 27 whose amount of information has been reduced to about a one-ninth, the matching processing being performed to detect motion vectors.

In FIG. 9A, plural straight lines (15 lines) passing through plural pixels (15 pixels) in the correlation search window 33 of the earlier frame 25 shown in FIG. 2 as well as through the motion vector detection position 31 are established, based on the motion vector detection position 31 in the interpolation frame 21 shown in FIG. 2. These straight lines are necessary for the motion vector-detecting portion 11 to perform the aforementioned matching processing. The straight lines also pass through the plural pixels (15 pixels) existing in the correlation search windows 37 in the 2-frames-earlier frame 27 and having a corresponding relationship with the pixels in the correlation search window 33. In the example shown in FIG. 9A, 91 pixels in total are arranged in a matrix array of 7 pixels tall×13 pixels wide in the correlation search window 37. The matching processing is unnecessary for 76 pixels (equal to 91 pixels minus 15 pixels).

In other words, the correlation search window 33 needs to be searched for all the pixels but the search window 37 needs to be searched for every fourth pixel.

Accordingly, with respect to the 2-frames-earlier frame 27, the pixels in the correlation search window 37 which are unnecessary for the matching processing are reduced by passing the signal through the second image information-reducing portion 151. A matrix-like region 38 in FIG. 9B shows a correlation search window in the 2-frames-earlier frame 27 whose amount of information has been reduced by the second image information-reducing portion 151.

In this way, the amount of information of the 2-frames-earlier frame 27 is reduced by the second image information-reducing portion 151 and so a memory having a smaller storage capacity than that of the first, second, fourth, and sixth frame memories (3, 5, 9, 147) can be used as the seventh frame memory 153 for temporarily holding the 2-frames-earlier frame 27.

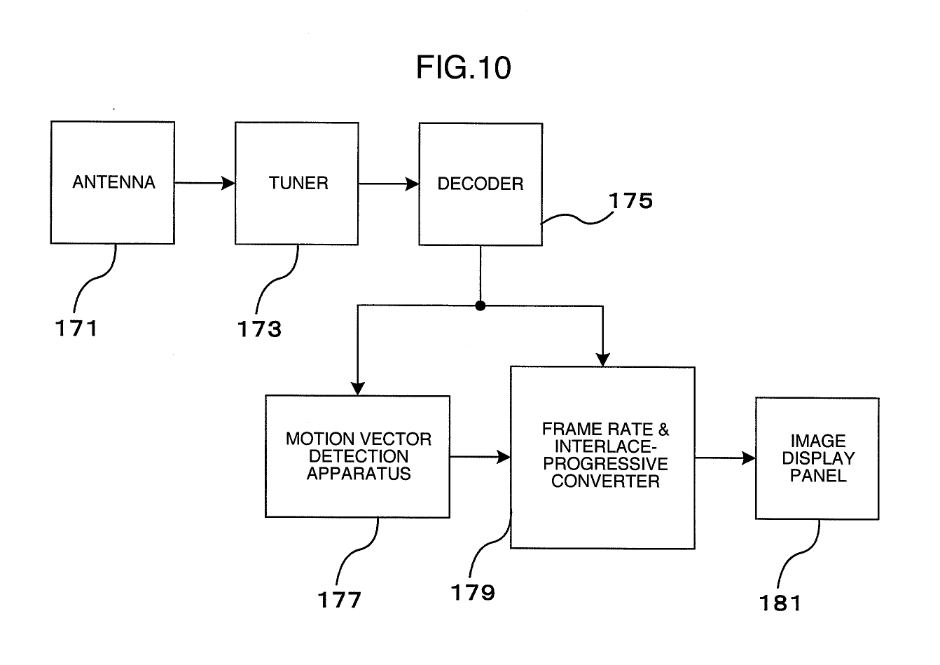

FIG. 10 is a functional block diagram showing the configuration of an image display device incorporating a motion vector detection apparatus associated with the present invention.

Referring to FIG. 10, digital TV broadcast airwaves received by an antenna 171 are outputted from the antenna 171 to a tuner 173. In the tuner 173, an image signal that the user wants to select is extracted from the broadcast airwaves. The image signal is decoded by a decoder 175. The decoded image signal is outputted to a motion vector detection apparatus 177 and to a frame rate & interface-to-progressive converter 179. In the motion vector detection apparatus 177, a series of processing operations for detecting motion vectors using the image signal in a manner as already described is performed. The detected motion vectors are outputted to the frame rate & interlace-to-progressive converter 179.

The frame rate & interlace-to-progressive converter 179 performs interlace-to-progressive conversion on the image signal from the decoder 175, based on the motion vectors supplied from the motion vector detection apparatus 177. The converter 179 may also perform a frame rate conversion. The output image signal from the converter 179 which has undergone the interlace-to-progressive conversion or both interlace-to-progressive conversion and frame rate conversion is outputted to an image display panel 181.

While preferred embodiments of the present invention have been described so far, it is to be understood that the embodiments are merely exemplary of the invention and that the scope of the present invention is not limited to only those embodiments. The invention can be practiced in various other embodiments.

It should be further understood by those skilled in the art that although the foregoing description has been made on embodiments of the invention, the invention is not limited thereto and various changes and modifications may be made without departing from the spirit of the invention and the scope of the appended claims.

1. A motion vector detection apparatus for finding motion vectors from an input image signal in a digital format, said motion vector detection apparatus comprising:
a first image signal delaying and outputting unit which outputs an image signal with a delay of a period of one frame with respect to the input image signal by holding the image signal entered from outside;
a second image signal delaying and outputting unit which outputs an image signal with a delay of a period of one frame with respect to the image signal entered to the second image signal delaying and outputting unit by holding the image signal from the first image signal delaying and outputting unit;
a third image signal delaying and outputting unit which outputs an image signal with a delay of a period of one frame with respect to the image signal entered to the third image signal delaying and outputting unit by holding the image signal from the second image signal delaying and outputting unit; and
a motion vector-detecting unit which performs given processing to detect motion vectors, using a frame of the input image signal entered directly from the outside via none of the first through third image signal delaying and outputting units as well as frames of the image signals respectively entered from the first through third image signal delaying and outputting units in synchronism with the frame of the input image signal entered directly from the outside.

2. The motion vector detection apparatus set forth in claim 1, wherein the given processing performed by said motion vector-detecting unit is calculation of interframe correlation of said image signal, and wherein the calculation of the interframe correlation is performed for each of the frame of the image signal directly entered from the outside and the frames of the image signals entered respectively from the first through third image signal delaying and outputting units in synchronism with the frame of the input image signal directly entered.

3. The motion vector detection apparatus set forth in claim 2, wherein said calculation of the interframe correlation is performed (i) between the frame of the input image signal directly entered from the outside and the frame of the image signal from the first image signal delaying and outputting unit, (ii) between the frame of the image signal from the first image signal delaying and outputting unit and the frame of the image signal from the second image signal delaying and outputting unit, or (iii) between the frame of the image signal from the second image signal delaying and outputting unit and the frame of the image signal from the third image signal delaying and outputting unit.

4. The motion vector detection apparatus set forth in claim 1, further comprising:
a past vector-detecting unit which performs processing on motion vectors about one frame outputted from said motion vector-detecting unit to find rates of appearance of the motion vectors and which performs processing on these motion vectors for taking a given number of motion vectors as past vectors in turn from one of the motion vectors having a highest rate of the appearance; and
a motion vector delaying and outputting unit which delays the past vectors outputted from the past vector-detecting unit with respect to the past vectors entered to the motion vector delaying and outputting unit by a period of one frame by holding past vectors outputted from the past vector-detecting unit and which outputs the delayed past vectors to the motion vector-detecting unit.

5. The motion vector detection apparatus set forth in claim 4, wherein said motion vector-detecting unit performs said calculation of the interframe correlation about regions each surrounded by four corners of each of frames including the frames of the image signals respectively outputted from the first through third image signal delaying and outputting units and the frame of the image signal directly entered from the outside while treating even the past vectors outputted from the past vector-detecting unit as candidates for motion vectors.

6. The motion vector detection apparatus set forth in claim 1, wherein computational processing performed by said motion vector-detecting unit to detect motion vectors includes at least:
a first process step for establishing a motion vector detection frame created between the frame of the image signal from said first image signal delaying and outputting unit and the frame of the image signal from said second image signal delaying and outputting unit;
a second process step for establishing plural straight lines passing through the frame of the input image signal directly entered from the outside and through the frames of the image signals respectively outputted from said first through third image signal delaying and outputting units, using certain pixels in said motion vector detection frame as a reference;
a third process step for finding (i) differences between the pixels which are in the frame of the input image signal directly entered from the outside and which are on the straight lines and pixels in the frame of the image signal from said first image signal delaying and outputting unit, (ii) differences between pixels which are in the frame of the image signal from said first image signal delaying and outputting unit and which are on the straight lines and pixels in the frame of the image signal from said second image signal delaying and outputting unit, and (iii) differences between pixels which are in the frame of the image signal from said second image signal delaying and outputting portion and which are on the straight lines and pixels in the frame of the image signal from said third image signal delaying and outputting unit;
a fourth process step for finding a sum value of the differences found in the third process step and taking the sum value as points for each of the straight lines; and
a fifth process step for using one of the straight lines which has the least point as a reference in determining motion vectors.

7. The motion vector detection apparatus set forth in claim 6, wherein in a case where the differences cannot be found from any one of said plural straight lines in said third process step, the differences that cannot be found are neglected and the found differences are corrected.

8. The motion vector detection apparatus set forth in claim 7, wherein in a case where the differences cannot be found from any one of said plural straight lines in said third process step, said motion vector-detecting unit gives appropriate points to one of the straight lines which is indicated by the past vectors from the past vector-detecting unit and performs said calculation of the interframe correlation, using the straight line to which the points have been given also as a candidate for a motion vector.

9. The motion vector detection apparatus set forth in claim 1, further comprising:
a first low-pass filter connected between an input side of said motion vector-detecting unit and an image signal input unit enabling the image signal from the outside to be entered to remove high frequency components included in the image signal;
a first information-reducing unit which reduces an amount of information of the image signal outputted from the first low-pass filter; and
a fourth image signal delaying and outputting unit which outputs an image signal with a delay of a period of one frame with respect to the image signal entered to the fourth image signal delaying and outputting unit by holding the image signal outputted from the first information-reducing portion.

10. The motion vector detection apparatus set forth in claim 9, further comprising a fifth image signal delaying and outputting unit connected between an input side of said first image signal delaying and outputting unit and said image signal input unit to output the image signal with a delay of a period of one frame with respect to the image signal entered to the fifth image signal delaying and outputting unit by holding the image signal from the image signal input unit.

11. The motion vector detection apparatus set forth in claim 10, further comprising:
a second low-pass filter connected between an output side of said third image signal delaying and outputting unit and an input side of said second image signal delaying and outputting unit to remove high frequency components included in the image signal; and
a second information-reducing unit which reduces an amount of information of the image signal outputted from the second low-pass filter.

12. The motion vector detection apparatus set forth in claim 10, wherein said third and fourth image signal delaying and outputting units have storage capacities set smaller than storage capacities of said first, second, and fifth image signal delaying and outputting units.

13. The motion vector detection apparatus set forth in claim 10, wherein reduction of an amount of information of the image signal entered from the image signal input unit through said first low-pass filter by the first information-reducing portion and reduction of an amount of information of the image signal entered from the image signal input unit through said second low-pass filter and through the second, first, and fifth image signal delaying and outputting units by the second information-reducing unit, are carried out about a rectangular region of the frame of each of these image signals except for outer fringe regions having a given width.

14. A motion vector detecting method for finding motion vectors from an image signal in a digital format, said motion vector detecting method comprising:
a first step of holding an image signal entered from outside to thereby output an image signal with a delay of a period of one frame with respect to the entered image signal;
a second step of holding an image signal outputted through the first step to thereby output an image signal with a delay of a period of one frame with respect to the entered image signal;
a third step of holding the image signal outputted through the second step to thereby output an image signal with a delay of a period of one frame with respect to the entered image signal; and
a fourth step of detecting motion vectors by performing given processing using various frames including the frame of the image signal entered directly from the outside via none of the first through third steps and the frames of the image signals outputted via the first through third steps, respectively, in synchronism with the frame of the image signal entered directly from the outside.

15. An image display device comprising:
an image signal-extracting device which extracts an image signal in a desired digital format from a received image signal;
a motion vector-detecting device which finds motion vectors from the image signal in the digital format extracted by the image signal-extracting device; and
a frame rate and interlace-progressive converter which performs a frame rate conversion or an interlace-progressive conversion on the image signal in the digital format extracted by the image signal-extracting device, based on the motion vectors outputted from the motion vector-detecting device;
wherein said motion vector-detecting device has: a first image signal delaying and outputting unit which outputs an image signal with a delay of a period of one frame with respect to the entered image signal by holding the image signal entered from the image signal-extracting device; a second image signal delaying and outputting unit which outputs an image signal with a delay of a period of one frame with respect to the image signal entered to the second image signal delaying and outputting unit by holding the image signal entered from the first image signal delaying and outputting unit; a third image signal delaying and outputting unit which outputs an image signal with a delay of a period of one frame with respect to the image signal entered to the third image signal delaying and outputting unit by holding the image signal entered from the second image signal delaying and outputting unit; and a motion vector-detecting unit which performs given processing to detect motion vectors, using various frames including the frame of the image signal entered directly from the image signal-extracting device via none of the first through third image signal delaying and outputting units and the frames of the image signals entered respectively from the first through third image signal delaying and outputting units in synchronism with the frame of the image signal entered directly from the image signal-extracting device.

16. The motion vector detection apparatus set forth in claim 11, wherein said third and fourth image signal delaying and outputting units have storage capacities set smaller than storage capacities of said first, second, and fifth image signal delaying and outputting units.
